(19) United States
(12) Patent Application Publication
(10) Pub. No.: US 2008/0259721 A1
(43) Pub. Date: Oct. 23, 2008

(54) Hopper with Flow Controller/Enhancer for Controlling the Gravitational Flow of Granular Material

(75) Inventor: Enrique Nieves-Vazquez, San Juan, PR (US)

Correspondence Address: HUSCH BLACKWELL SANDERS LLP, 720 OLIVE STREET, SUITE 2400, ST. LOUIS, MO, 63101, US

(73) Assignee: MOVA PHARMACEUTICAL CORPORATION, Caguas (PR)

(21) Appl. No.: 10/596,583

(22) PCT Filed: Dec. 16, 2004
(86) PCT No.: PCT/US04/42099

§ 371 Date: Nov. 12, 2007

Related U.S. Application Data
(60) Provisional application No. 60/530,376, filed on Dec. 17, 2003.

(51) Int. Cl. G05D 11/02

(52) U.S. Cl. 366/152.2

(57) ABSTRACT

A hopper assembly for feeding granular material, such as pharmaceutical powder, includes a hopper having an upper inlet and a lower outlet defining a substantially vertical center axis, and a flow controller/enhancer disposed in the hopper adjacent the outlet. The flow controller/enhancer includes a deflector element disposed in the hopper above the outlet. The deflector element is of generally conical shape with an apex thereof directed upwardly in substantial alignment with the vertical center axis. An outer peripheral edge of the deflector element is spaced inwardly from an inner surface of the hopper to define a space therebetween where gravitating granular material deflected outwardly by the deflector element flows downwardly past the deflector element toward the outlet.

### BACKGROUND OF THE INVENTION

The present invention relates to the gravity feeding of granular material and, in particular to achieving a uniform outflow of granular material, such as powder, from the bottom discharge end of a hopper.

It is conventional in the manufacture of pharmaceutical tablets to deliver a granular material such as powder, to a feed frame which includes pockets which receive the powder. The powder is then compacted under high pressure to form the tablets. Since the powder typically contains a mixture of different components, e.g., the active ingredient and one or more excipients, it is important that the powder being discharged be of highly uniform mixture.

One factor that can have an adverse effect on that goal is so-called “funnel-flow” wherein the center region or core of the gravitating powder flows faster than the outer annular regions, causing denser particles to become segregated from less dense particles.

Another factor is a tendency for some granular materials, especially those characterized by a large angle of repose, to become compacted at the bottom of the hopper and thus be resistant to flow. Efforts to overcome that problem have included the mechanical application of a downward force on top of the granular material to induce flow. However, such forces can break the particles and affect the therapeutic properties of the formula.

Therefore, it is an object to minimize or obviate that problem.

### SUMMARY OF THE INVENTION

The present invention involves an apparatus for feeding granular material, comprising a hopper having an upper inlet and a lower outlet and defining a substantially vertical center axis, and a flow controller/enhancer disposed in the hopper adjacent the outlet. The flow controller/enhancer includes a deflector element disposed in the hopper above the outlet. The deflector element is of generally conical shape with an apex thereof directed upwardly in substantial alignment with the vertical center axis. An outer peripheral edge of the deflector element is spaced inwardly from an inner surface of the hopper to define a space therebetween where gravitating granular material, including granular material deflected outwardly by the deflector element, flows downwardly past the deflector element toward the outlet.

### BRIEF DESCRIPTION OF DRAWINGS

The objects and advantages of the invention will become apparent from the following detailed description of a preferred embodiment thereof in connection with the accompanying drawings in which like numerals designate like elements.

FIG. 1 is a side elevational view of a conventional hopper used to feed powder in the making of pharmaceutical tablets.

FIG. 2 is a vertical sectional view taken through the hopper of FIG. 1 showing a flow controller/enhancer disposed in the hopper, according to the invention.

FIG. 3 is a top plan view of the flow controller/enhancer.

FIG. 4 is a side elevational view of the flow controller/enhancer.

### DETAILED DESCRIPTION OF A PREFERRED EMBODIMENT

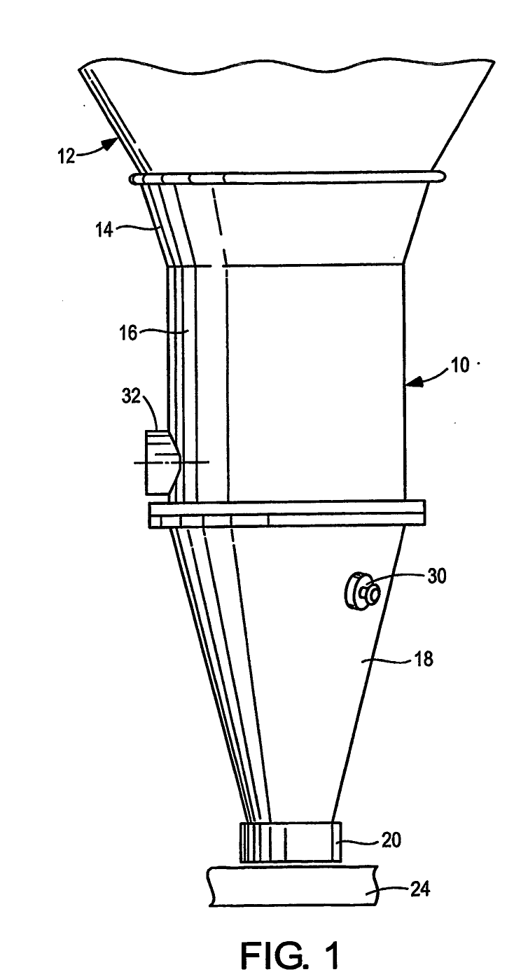

Depicted in FIG. 1 is a side elevational view of a hopper 10, preferably of the type used to conduct a gravitational flow of granular material, such as powder for making pharmaceutical tablets. However, it will be appreciated that the present invention has utility in the gravitational feeding of granular materials that have uses in fields other than pharmaceutical.

The hopper is adapted to be disposed beneath a larger bin 12 which feeds the powder into an upper end of the hopper 10 defined by an upper frusto-conical section 14. The powder then flows through a cylindrical section 16 and into a frusto-conical lower section 18 of the hopper. From there, the powder flows through a cylindrical section 20 which defines the outlet 22. Disposed beneath the outlet 22 is a conventional feed frame 24 (see FIG. 1) which includes a plurality of pockets which receive the powder as the feed frame 24 passes across the outlet. The powder enters the pockets and is eventually compressed to form tablets. The hopper includes a conventional sampling port 30 and glass sight 32.

As explained earlier, there may be a tendency for so-called funnel flow to develop within the hopper, wherein the center portion of the powder gravitates faster than the outer portion of the powder, which can result in segregation of more dense particles from less dense particles. In the case of a pharmaceutical tablet-forming apparatus, that can lead to the discharge of a non-uniform powder mixture whereby the proper ratio of active ingredients to excipients is not achieved.

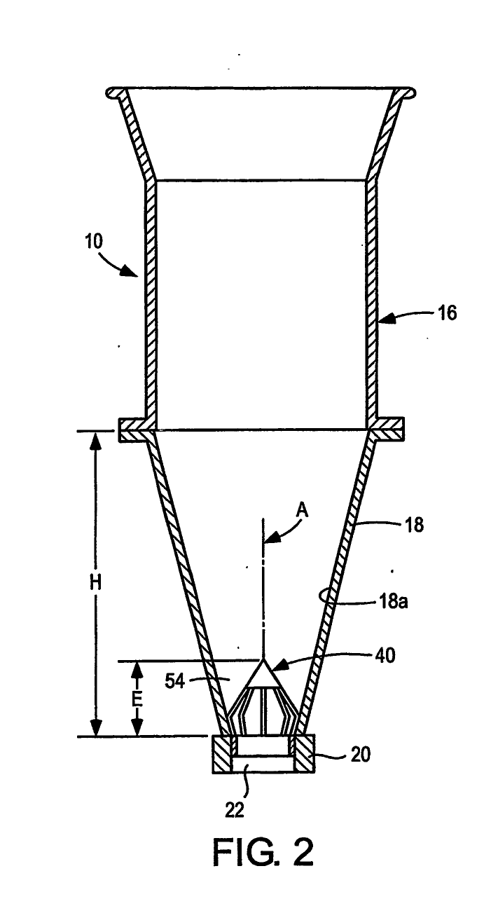

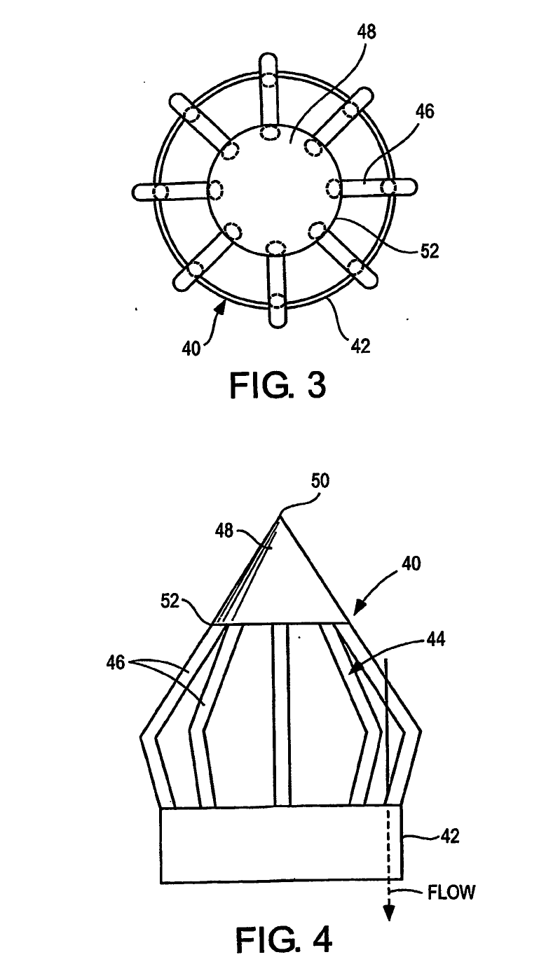

The present invention obviates that problem by positioning a flow controller/enhancer 40 immediately above the outlet of the hopper, as depicted in FIG. 2. The flow controller/enhancer, depicted also in FIGS. 3 and 4, comprises a cylindrical mounting portion 42, a support structure 44 in the form of a plurality of legs 46 projecting upwardly from the mounting portion 32, and a diverter element 48 mounted atop the legs 46.

The mounting portion 42 comprises a cylindrical ring sized to fit within the cylindrical section 20 of the hopper, preferably by a friction fit, whereby the flow controller/enhancer is removable from the hopper. Other types of releasable connections could be used instead.

The diverter element 48 is of conical shape, with a sharp apex 50 thereof directed upwardly and lying on a central vertical axis A of the hopper. The cone preferably has a solid upwardly facing surface upon which the central portion of the gravitating granular mass impinges so as to be deflected laterally outwardly thereby in order to prevent the establishment of funnel flow. That is, powder particles tending to flow rapidly through the center of the hopper are instead diverted outwardly, to prevent segregation between high and low density particles. Instead, he granular material gravitates as a “mass flow”. The outer peripheral edge 52 of the cone 48 is spaced laterally inwardly from an inner surface 18a of the conical section 18 of the hopper to create therebetween an annular space 54 through which the particles can flow in order to pass between the legs 46 en route to the outlet 22.

The presence of the flow controller/enhancer just above the outlet serves to minimize the vertical load applied to the granular material disposed beneath the flow controller/enhancer/enhancer. Consequently, compaction of the granular material is minimized, and the flow is enhanced without the need for mechanically applying a downward force to the granular material.

The cone extends to an elevation E within the frusto-conical section 18 which is no greater than 25% of the height H of that section. For example, in a hopper of about 29.5 inches high, having a frusto-conical section 18 of about 13 inches high, a flow controller/enhancer 40 which extends to an elevation E of about 4 inches is suitable.

It will be appreciated that the flow controller/enhancer 40 is not limited to use in frusto-conical hopper sections, but could be employed in cylindrical hopper sections.

While the controller/enhancer 40 could be permanently fixed to the hopper instead of releasably connected, it is preferable for the controller/enhancer to be removable to enable the hopper to be used to feed granules that do not require the use of a flow controller/enhancer.

Instead of employing a support structure 44 comprised of bent legs 46, a different support structure could be used, such as radial spokes arranged in the cylindrical ring 42 with a vertical leg projecting upwardly from a center of the spoke arrangement to carry the cone, for example.

The flow controller/enhancer 40 can be formed of any suitable material which is compatible with the granules being fed, such as stainless steel. The cone need not be solid, but could be perforated to a limited extent in order to allow a restricted amount of powder flow which is insufficient to establish “funnel flow”.

Although the present invention has been described in connection with preferred embodiments thereof, it will be appreciated by those skilled in the art that other additions, deletions, modifications, and substitutions not specifically described may be made without departing from the spirit and scope of the invention as defined in the appended claims.

What is claimed is:

1. Apparatus for feeding granular material, comprising:
a hopper having an upper inlet and a lower outlet, the outlet defining a substantially vertical center axis, and
a flow controller/enhancer disposed in the hopper adjacent the outlet, the flow controller/enhancer including a deflector element disposed in the hopper above the outlet, the deflector element being of generally conical shape with an apex thereof directed upwardly in substantial alignment with the vertical center axis, an outer peripheral edge of the deflector element spaced inwardly from an inner surface of the hopper to define a space therebetween where gravitating granular material, including granular material deflected outwardly by the deflector element, flows downwardly past the deflector element toward the outlet.

2. The apparatus according to claim 1 wherein the flow controller/enhancer further comprises a support structure extending upwardly within the hopper, the deflector element being carried at an upper end of the support structure.

3. The apparatus according to claim 2 wherein the flow controller/enhancer further comprises a mounting portion connected to the hopper and to which a lower portion of the support structure is fixed.

4. The apparatus according to claim 3 wherein the hopper includes a frusto-conical portion having a cross section narrowing toward the outlet.

5. The apparatus according to claim 4 wherein the apex of the deflector element extends to an elevation within the hopper no greater than about 25% of a height of the frusto-conical section.

6. The apparatus according to claim 5 wherein the support structure comprises a plurality of upwardly projecting legs spaced circumferentially around the mounting portion.

7. The apparatus according to claim 6 wherein a lower end of the hopper includes a cylindrical portion defining the outlet, the mounting portion comprising a circular ring disposed in contact with an inner surface of the cylindrical portion.

8. The apparatus according to claim 7 wherein each leg includes a lower portion inclined upwardly and outwardly form the ring, and an upper portion inclined upwardly and inwardly toward the deflector element.

9. The apparatus according to claim 8 wherein the lower portions of the legs are inclined at the same angle as an inner surface of the frusto-conical portion of the hopper and bear against such inner surface.

10. The apparatus according to claim 7 wherein the ring is removably secured by a friction fit against the inner surface of the cylindrical portion of the hopper.

11. The apparatus according to claim 10 wherein the deflector element includes an upwardly facing solid conical surface.

12. The apparatus according to claim 1 wherein the support structure comprises a plurality of upwardly projecting legs spaced circumferentially around the mounting portion.

13. The apparatus according to claim 12 wherein a lower end of the hopper includes a cylindrical portion defining the outlet, the mounting portion comprising a circular ring disposed in contact with an inner surface of the cylindrical portion.

14. The apparatus according to claim 13 wherein each leg includes a lower portion inclined upwardly and outwardly form the ring, and an upper portion inclined upwardly and inwardly toward the deflector element.

15. The apparatus according to claim 1 wherein the flow controller/enhancer is removably secured to the hopper.

16. The apparatus according to claim 15 wherein the flow controller/enhancer is removably secured by a friction fit against the inner surface of the hopper.

17. The apparatus according to claim 1 wherein the deflector includes an upwardly facing solid conical surface.

18. An apparatus for making tablets from powder comprising:
a hopper having an upper powder inlet and a lower powder outlet, the outlet defining a substantially vertical center axis;
a powder flow controller/enhancer disposed in the hopper adjacent the outlet and including a mounting portion connected to the hopper, a support structure projecting upwardly into the hopper from the mounting portion, and a deflector element disposed at an upper end of the support element and being of generally conical shape with an apex thereof directed upwardly and substantially aligned with the vertical center axis for deflecting gravitating powder outwardly prior to reaching the outlet; and
a feed frame disposed beneath the outlet and being movable across the outlet, for receiving powder form the outlet as the feed frame moves across the outlet.
